(19) United States
(12) Patent Application Publication
(10) Pub. No.: US 2007/0031187 A1
(43) Pub. Date: Feb. 8, 2007

(54) Tubing frame connection insert

(75) Inventors: Chad McNeal, Chicago, IL (US); Michael Rogers, Evanston, IL (US)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignee: Dimension Design, Northbrook, IL (US)

(21) Appl. No.: 11/197,026

(22) Filed: Aug. 4, 2005

(51) Int. Cl. F16B 7/00

(52) U.S. Cl. 403/297

(57) ABSTRACT

A connector used to secure together a first and second piece of tubing. The connector has a tubular section that includes a slot in a first side, and at least one opening in a second side that is substantially perpendicular to the first side. The slot is defined by a first and second side wall that are spaced apart from each other and a rounded bottom wall that connects the two side walls. The first side wall has an opening aligned with the at least one opening in the second side of the tubular section. The slot extends into the tubular section from the first side to a depth greater than half a diameter, but less than a full diameter of the section. An engagement screw is positioned within the at least one opening for use in tightening the connector within the tubing.

### FIELD OF THE INVENTION

This invention pertains to a connection device used to connect together various sections of tubing when assembling a frame structure.

### BACKGROUND OF THE INVENTION

The use of tubular connection inserts to join together a first and second piece of tubing in order to construct a frame such as the type used with an exhibit display at a convention or trade show are well known in the art. Known inserts are made of metal and have a slot that extends the full diameter of the insert where it is terminated only by the outer surface insert itself. This design results in the outer surface of the insert acting as the flex area of the connector when it is tightened into position.

The current connector design has many shortcomings including the fact that the inserts are heavy, the flex area is prone to splitting, and the connectors allow for rotation of the connected pieces of tubing even when the connector is at its maximum expansion point. Furthermore, the manufacturing process required to make the known connectors is labor intensive and utilizes costly materials.

Another shortcoming of the prior art is that expansion of the connector may cause ovilization of the pieces of tubing being connected (i.e., change the shape of the tube from circular to oval). This results from the fact that the known connectors do not contact the inner wall of the tubing pieces throughout a majority of the 360° of the tubing's inner diameter, but only at two oppositely opposed areas. This problem becomes more egregious if you attempt to reduce the weight of the known connectors by reducing their outside diameter in an attempt to reduce their material weight. For these reasons a lightweight connector that has a resilient flex area, is easy to install, and will not deform the shape of the tubing pieces that are being connected together would be an important improvement in the art.

### BRIEF SUMMARY OF THE INVENTION

The invention involves a connector used to secure together a first and second piece of tubing. The connector is comprised of a tubular section that includes a slot in a first side, and at least one opening in a second side that is substantially perpendicular to the first side. The slot is defined by a first and second side wall that are spaced apart from each other and a rounded bottom wall that connects the two side walls. The first side wall has an opening aligned with the at least one opening in the second side of the tubular section. The slot extends into the tubular section from the first side to a depth greater than half a diameter, but less than a full diameter of the section. An engagement screw is positioned within the at least one opening.

### BRIEF DESCRIPTION OF THE DRAWINGS

FIG. 1 is a perspective view of a known connector having a slot that extends the entire length of the diameter of the connector.

FIG. 1A is a sectional view of a known connector deforming a piece of tubing as an engagement screw expands the slot of the connector causing the connector to separate from the inner surface of the tubing

FIG. 2A is a perspective view of a connector having an opening for an engagement screw in one side.

FIG. 2B is a perspective view of a connector having two openings for engagement screws in one side.

FIG. 3 is a perspective view showing a connector installed being installed in a first piece of tubing, and a second piece of tubing in line with the first.

FIG. 4A is an end view of the connector showing the spacing of the slot in the neutral, non-engaged position.

FIG. 4B is an end view of the connector showing in phantom the width of the slot expanded by the engagement screw.

FIG. 5 is a perspective view showing the connector in phantom joining together a first and second piece of tubing

FIG. 6 is a perspective view of the connector showing the sleeve that may be inserted in the opening in the connector to receive the engagement screw.

### DETAILED DESCRIPTION OF THE INVENTION

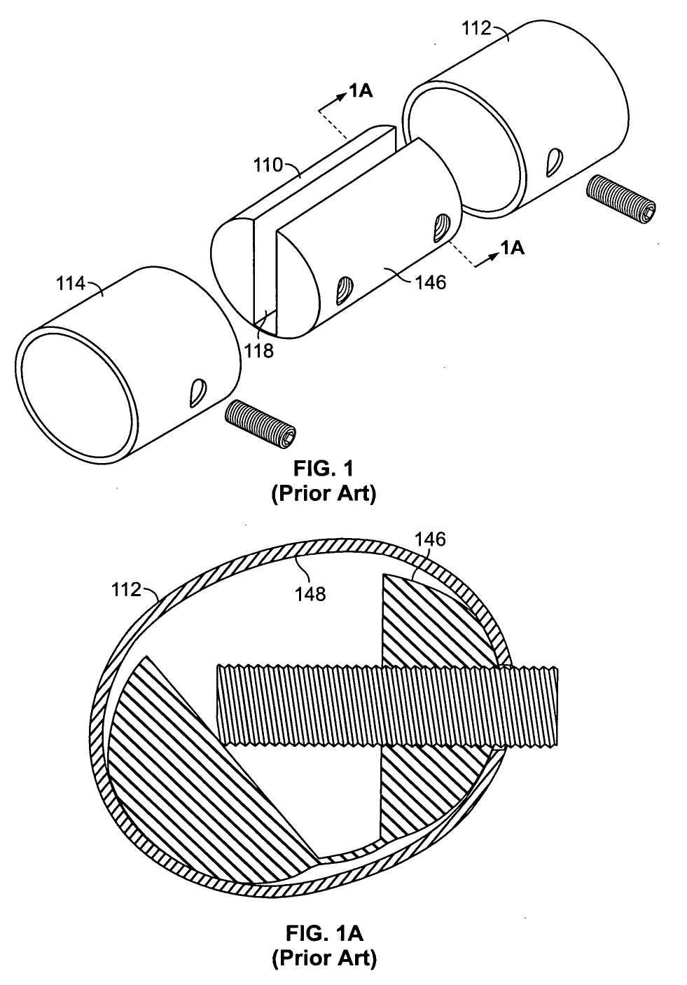

FIGS. 1 and 1A show the current state-of-the-art connectors 110 that are used to join various pieces of tubing 112, 114. These known connectors 110 have a slot 118 that extends the length of the diameter of the connector 110. As can be seen in FIG. 1A, over time this type of known connector 110 loses its flexure, thereby causing the outer surface 146 of the connector 110 to contact a smaller portion of the inner surface 148 of the tubing 112 thus causing the tube 112 to deform into an oval shape.

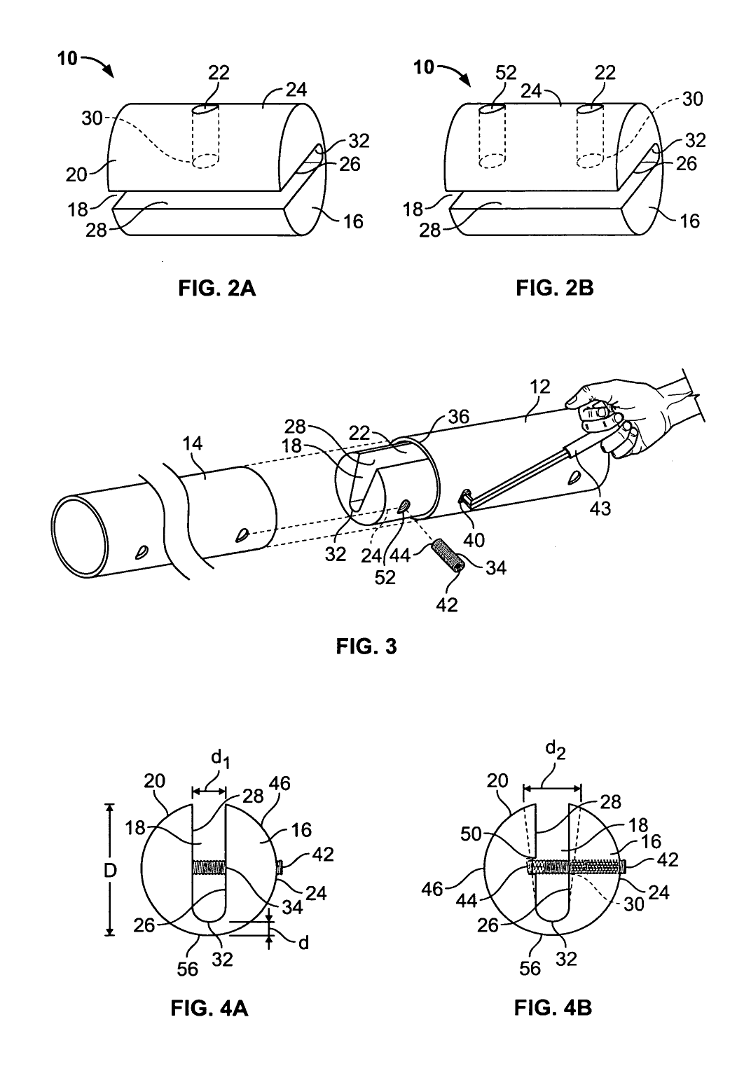

As shown in FIGS. 2A-6, the invention involves a connector 10 that is used to join together a first 12 and second 14 piece of tubing. The connector 10 is comprised of a tubular section 16 that has a slot 18 in a first side 20 and at least one opening 22 in a second side 24 that is substantially perpendicular to the first side 20. The slot 18 is defined by a first 26 and second 28 side wall spaced apart from each other, the first side wall 26 having an opening 30 aligned with the at least one opening 22 in the second side 24 of the tubular section 16. A rounded bottom wall 32 connects the two side walls 26, 28 at a depth greater than half a diameter, but less than a full diameter of the tubular section 16. An engagement screw 34 is positioned within the at least one opening 22.

As seen in FIG. 3, in one embodiment, the engagement screw 34 may have a first end 42 that is capable of engaging a torque-applying implement 43 such as a screwdriver, Allen wrench, pliers, or an adjustable wrench. The second end 44 of the engagement screw 34 is capable of contacting the second side wall 28 that defines the slot 18.

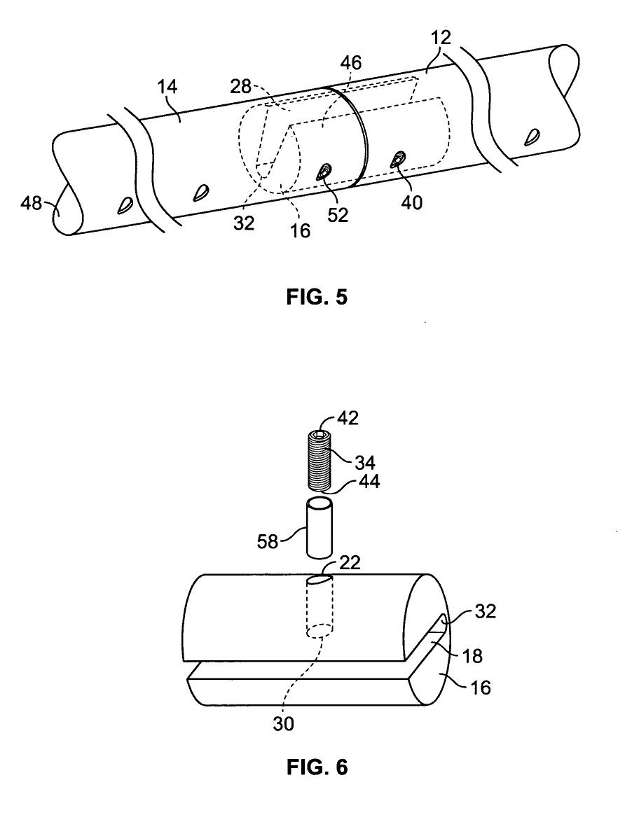

When in operation, the connector 10 is inserted in an opening 22 in one end 36 of a section or piece of tubing 12. The engagement screw 34 is then inserted into the connector 10 through a second opening 40 in the section of tubing 12 that is aligned with the at least one opening 22 in the second side 24 of the connector 10. When toque is applied to the first end 42 of the engagement screw 34, the second end 44 screws through the first side wall 26 across the slot 18 and contacts the second side wall 28. As torque continues to be applied, the second end 44 of the engagement screw 34 forces the second side wall 28 away from the first 26. This increases the distance between the first and second side walls 26, 28 and forces the outer surface 46 of the connector 10 against the inner surface 48 of the section of tubing 12, thereby securing the connector 10 within the tubing 12, as shown in FIG. 5.

In an embodiment, as shown in FIG. 4B, the second side wall 28 of the slot 18 defines a recessed opening 50 that is aligned with the opening 30 in the first side wall 26. This recessed opening 50 is capable of receiving the second end 44 of the engagement screw 34.

The connector 10 can be made of any suitable material without departing from the scope and spirit of the invention. For example, in one embodiment, the tubular section 16 may be made from a malleable material. In another embodiment, the tubular section 16 may be made of a molded plastic. The plastic may be any number of compounds including polyurethane and any thermal plastic resin.

The use of plastic or other more malleable materials allows the connector 10 to flex and expand more easily when tightened into position within the tubing pieces 12, 14. This results in a greater portion of the outer wall 46 of the connector 10 contacting the inner wall 48 of the tubing 12, thereby providing a more even distribution of the expansion force generated by the connector 10 on the tubing 12. This even distribution of the expansion force allows the tubing 12 to maintain a more circular shape thus preventing ovilization of the tube 12.

Depending on the length of the connector 10, a second opening 52 may be defined in the second side 24 of the tubular section 16, as shown in FIGS. 2B, 3, and 5. This second opening 52 also extends through the first side wall 26 and receives a second engagement screw 34. When in use, this second opening 52 is aligned with an opening 54 in the second section piece of tubing 14 that is to be connected with the first section of tubing 12.

As shown in FIG. 4A, the bottom wall 32 defining the slot 18 is displaced a distance “d” from a side 56 of the tubular section 16 opposite the slot 18 so as to establish the depth of the slot 18. Although the depth of the slot 18 can vary, in one embodiment the slot 18 extends into the tubular section 16 to such a depth that the ratio of the diameter “D” of the tubular section 16 to the distance “d” the bottom wall is displaced from the side 56 of the tubular section 16 opposite the slot 18 is at least approximately 16:1.

In another embodiment of the invention, a threaded sleeve 58 may be inserted into the at least one opening 22, as shown in FIG. 6. In this embodiment, the engagement screw 34 is received in the threaded sleeve 58. The threaded sleeve 58 may be made of any suitable material including, but not limited to, plastic.

With respect to the slot 18, as seen in FIG. 4A, the first side wall 26 and the second side wall 28 are separated by a first distance “d₁.” Although this distance can vary, in one embodiment the ratio of the diameter “D” of the tubular section 16 to the first distance “d₁” is approximately 8:1.

As shown in FIGS. 4B and 5, when in operation as the first end 42 of the engagement screw 34 is rotated, the second end 44 of the screw 34 pushes the second wall 28 away from the first wall 26 to a distance of “d₂,” thereby forcing the outside wall 46 of the connector 10 against the inner wall 48 of the tubing 12 so as to secure the connector 10 within the section of tubing 12. To release the connector 10, the operator merely loosens the screw 34. This draws the second end 44 of the screw 34 away from the second wall 28, thereby allowing the distance between the two side walls 26, 28 to return to “d₁.” As the second side wall 28 moves back closer to the first side wall 26, the outer wall 46 of the connector 10 is released from the inner wall 48 of the section of tubing 12, thereby freeing the connector 10 from the tubing 12.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A connector used to join together a first and second piece of tubing, the connector comprised of:
a tubular section, the tubular section having a slot in a first side and at least one opening in a second side substantially perpendicular to the first side;
the slot is defined by a first and second side wall spaced apart from each other, the first side wall having an opening aligned with the at least one opening in the second side of the tubular section, and a rounded bottom wall connecting said side walls at a depth greater than half a diameter, but less than a full diameter of the tubular section; and
an engagement screw positioned within the at least one opening.

2. The connector of claim 1, wherein:
the engagement screw has a first end a second end;
the first end is capable of engaging a torque-applying implement; and
the second end contacts the second side wall.

3. The connector of claim 2, wherein the second end of the engagement screw forces the second side wall away from the first side wall when torque is applied to the first end of the engagement screw, thereby securing the connector within a piece of tubing.

4. The connector of claim 2, wherein:
the second side wall defines a recessed opening aligned with the opening in the first side wall; and
the second end of the engagement screw is received in the recess.

5. The connector of claim 1, wherein the tubular section is comprised of a malleable material.

6. The connector of claim 1, wherein the tubular section is made of a molded plastic.

7. The connector of claim 6, wherein the molded plastic is polyurethane.

8. The connector of claim 1, further comprising:
a second opening defined in the second side of the tubular section, said second opening extending through the first side wall; and
a second engagement screw positioned within the second opening.

9. The connector of claim 1, wherein:
the bottom wall is displaced a distance from a side of the tubular section opposite the slot; and
the ratio of the full diameter to the distance the bottom wall is displaced from the side of the tubular section opposite the slot is at least approximately 16:1.

10. The connector of claim 1, further comprising:
a threaded sleeve inserted into the at least one opening; and
the engagement screw received in the threaded sleeve.

11. The connector of claim 1, wherein the threaded sleeve is made of a plastic material.

12. The connector of claim 1, wherein:
the first side wall and the second side wall are separated by a first distance; and
the ratio of the full diameter of the tubular section to the first distance is approximately 8:1.
